(19) United States
(12) Patent Application Publication
(10) Pub. No.: US 2017/0160182 A9
(43) Pub. Date: Jun. 8, 2017

(54) ROTATABLE PLATFORM DEVICES AND SYSTEMS

(71) Applicant: EMORY UNIVERSITY, Atlanta, GA (US)

(72) Inventors: Jeremy David Ackerman, Atlanta, GA (US); Mark Patrick McJunkin, Peachtree City, GA (US); Kai Chieh Chiang, San Francisco, CA (US)

(21) Appl. No.: 14/784,694

(22) PCT Filed: Apr. 15, 2014
(86) PCT No.: PCT/US2014/034153

§ 371 Date: Mar. 6, 2016

Related U.S. Application Data
(60) Provisional application No. 61/812,237, filed on Apr. 15, 2013.

(51) Int. Cl. G01N 15/08; G01N 15/02

(52) U.S. Cl. CPC G01N 15/088; G01N 15/0205

(57) ABSTRACT

The devices can improve rotational movement substantially without or with significant reduction in mechanical interference. The devices can be configured to independently rotate a module about two substantially aligned perpendicular axes. The devices can include a first motor; a second motor; a first frame, the first motor and the second motor within the first frame, the first motor and the second motor being adjacent; a second frame, the first frame being above the second frame; and a module rotatably disposed to the second frame. The first motor can be configured to cause the module and the second frame to rotate with respect to the first frame about the first axis. The second motor can be configured to cause the module to rotate with respect to the second frame about the second axis.

### CROSS REFERENCE TO RELATED APPLICATION

This application claims priority to Provisional Application Ser. No. 61/812,237 filed Apr. 15, 2013, which is hereby incorporated by reference in its entirety.

### BACKGROUND

Currently, many rotatable platform devices, for example, to position a light source, experience mechanical interference. Additionally, to achieve rotation in more than one axis, these devices are not capable of having a compact design and generally require significant computation.

### SUMMARY

Thus, there is a need for new rotatable platform devices capable of having a compact design and configured to precisely rotate a module, such as a light source, without mechanical interference.

In some embodiments, the disclosure relates to a device configured to independently rotate a module about a first or primary axis and about a second or secondary axis substantially perpendicular to the first axis. The device may include a first motor; a second motor; a first frame; a second frame, the first frame being above the second frame; and a module rotatably disposed to the second frame. In some embodiments, the first motor may be configured to cause the module and the second frame to rotate with respect to the first frame about the first axis; and the second motor may be configured to cause the module to rotate with respect to the second frame about the second axis. In some embodiments, the first motor and the second motor are disposed adjacent to each other. In some embodiments, the first motor and the second motor are disposed within the first frame.

In some embodiments, each of the motors may include a shaft; and the shaft of the first motor and the shaft of the second motor may be substantially aligned.

In some embodiments, the first motor and the second motor may be fixedly disposed to a frame. In some embodiments, the first motor and the second motor may be rotatably disposed with respect to a frame. In some embodiments, the first motor may be disposed adjacent to the second motor.

In some embodiments, the device may include a plurality of shafts. In some embodiments, the first motor may be disposed with respect to a first drive shaft. In some embodiments, the second motor may be disposed between a second drive shaft and the first drive shaft. In some embodiments, at least one of the first drive shaft and the second drive shaft may be fixedly disposed with respect to a frame.

In some embodiments, the device may include a first mechanical drive member; a second mechanical drive member; a first set of rotatable members; and a second set of rotatable members. Each set of rotatable members may include at least two rotatable members. In some embodiments, at least one of the first set of rotatable members may be mounted on the shaft of the first motor and at least another one of the first set of rotatable members may be mounted on the second frame. In some embodiments, at least one of the second set of rotatable members may be mounted on the shaft of the second motor and at least another one of the second set of rotatable members may be mounted on the second frame. In some embodiments, the first mechanical drive member may be disposed between the first set of rotatable members. In some embodiments, the second mechanical drive member may be disposed between the second set of rotatable members. In some embodiments, the at least one of the second set of rotatable members may be configured to move with at least one of the first set of rotatable members when the module is caused to rotate only about the first axis.

In some embodiments, the second frame may include an opening. In some embodiments, the device may further include at least a first gear and a second gear, the first gear being rotatably connected to the one of the second set of rotatable members, the second gear being disposed on the second frame adjacent to the first gear; and a rack disposed on the second frame surrounding the opening. In some embodiments, the first gear and the second gear may be configured to engage the rack so as to cause the rack to rotate and thereby cause the module to rotate about the secondary axis. In some embodiments, the device may further include a third gear disposed on the second frame adjacent to the first gear. The first gear may be disposed between the second gear and the third gear with respect to the second frame. The second gear and the third gear may be disposed at opposing sides of the second frame.

In some embodiments, the device may further include a third frame, wherein the third frame is configured to surround the first frame and the second frame, the third frame including a first end and an opposing second end. In some embodiments, the first frame may be configured to be disposed near the first end of the third frame. In some embodiments, the first drive shaft and the second drive shaft may be fixedly disposed with respect to a frame.

In some embodiments, the device may further include a fourth frame. The fourth frame may be configured to be disposed near the second end of one of the frames.

In some embodiments, the first frame and/or the third frame may include at least one connector configured to fixedly dispose the first frame to the third frame. The connector may be an aperture.

In some embodiments, the device may further include at least one extending member, the at least one extending member configured to extend through the aperture. In some embodiments, the device may include at least two extending members configured to extend through respective apertures provided in the third frame and/or the first frame. In some embodiments, at least one shaft may correspond to the at least one extending member.

In some embodiments, the third frame may include at least two connectors configured to receive the extending member, each of the connectors configured to be disposed on opposing sides of the third frame.

In some embodiments, the module may include at least one of a light source, a platform, or an optical element. In some embodiments, the module may include a heat sink.

### BRIEF DESCRIPTION OF THE DRAWINGS

The disclosure can be better understood with the reference to the following drawings and description. The components in the figures are not necessarily to scale, emphasis being placed upon illustrating the principles of the disclosure.

FIG. 1 shows a perspective view of a device according to embodiments;

FIG. 2 shows a top view of the device;

FIG. 3 shows a front view of the device;

FIG. 4 shows a bottom view of the device;

FIG. 5 shows a side view of the device;

FIG. 6 shows an exploded view of the device;

FIG. 7 shows a perspective view of a device according to embodiments;

FIG. 8 shows a side view of the device;

FIG. 9 shows a perspective view of a device according to embodiments;

FIG. 10 shows a perspective view of a device according to embodiments;

FIG. 11 shows a partially exposed view of the device;

FIG. 12 shows a perspective view of a device according to embodiments;

FIG. 13 shows another view of the device;

FIG. 14 shows a partially exploded view of the device;

FIG. 15 shows a perspective view of a device according to embodiments;

FIG. 16 shows a partially exploded view of the device;

FIG. 17 shows another partially exploded view of the device;

FIG. 18 shows a perspective view of a device according to embodiments;

FIG. 19 shows a partially exploded view of the device; and

FIG. 20 shows another view of the device.

### DETAILED DESCRIPTION OF THE EMBODIMENTS

The following description, numerous specific details are set forth such as examples of specific components, devices, methods, etc., in order to provide a thorough understanding of embodiments of the disclosure. It will be apparent, however, to one skilled in the art that these specific details need not be employed to practice embodiments of the disclosure. In other instances, well-known materials or methods have not been described in detail in order to avoid unnecessarily obscuring embodiments of the disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

It will be understood that the rotatable platform devices and systems are not limited to the rotating a lighting source as shown in some of the figures. It will be understood that it is within one of ordinary skill to modify the devices for use with any module. A “module” can include but is not limited to at least one of any lighting source, any optical element (e.g., lens, a mirror, or prism), among others, or a combination thereof.

The disclosed rotatable platform devices can improve rotational movement substantially without or with significant reduction in mechanical interference. The disclosed rotational platform devices can be configured to independently rotate a module about two substantially aligned perpendicular axes. The disclosed devices can allow for movement of the module through about 360 degrees in both axes substantially without mechanical interference. For applications, for example, involving an optical element or an element that otherwise extends beyond the devices, movement can be restricted to about 180 degrees in each axis.

The disclosed devices can allow for linear adjustments, particularly for small variations from the origin. The disclosed devices can use the intersection of the prime meridian and equator as the origin of movement. Conventional devices, however, generally use a pole of the sphere as the origin and require calculation of sine and cosine to translate movement into Cartesian coordinates even for small movements from the small movements. Thus, the disclosed rotatable platform devices can also reduce the computation requirements required to move the module in Cartesian space (e.g., for example, moving a light source to a specific point on a grid representing a space (e.g., a floor)).

In some embodiments, the motors can be mounted above and not on the axes of rotation. This can reduce the moving weight and can simplify balance of the weight on the moving element (e.g., module). Additionally, by mounting the motors above, the mechanical envelope size can be reduced and modular placement can be allowed.

In some embodiments, the disclosed devices can also be capable of a reduced mechanical size, if desired. For example, the rotatable platform devices and/or system may be configured for modular placement. In some embodiments, the rotatable platform devices can be configured to fit within a ceiling or a wall. In some embodiments, the rotatable platform devices may be configured to fit retroactively into existing light fixtures, including but not limited to wall sconces and recessed lighting fixtures. The rotatable platform devices may also be configured to protrude from the ceiling and/or wall. In some embodiments, the rotatable platform devices may be configured to be substantially flush with the ceiling and/or wall. Thus, the rotatable platform devices can be configured to be immediately installed without the need for any construction. In other embodiments, the rotatable platform devices can be configured to be attached to any known fixture, mount or stand. However, it will be understood that the rotatable platform devices are not limited to that application and/or size, and can be of any scale.

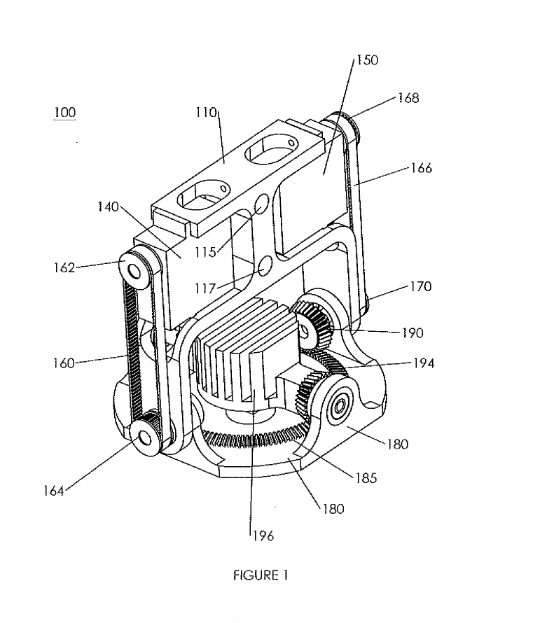

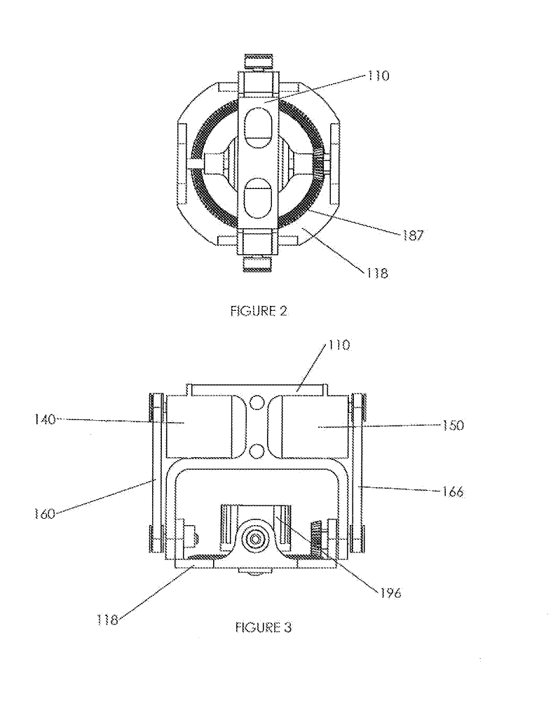

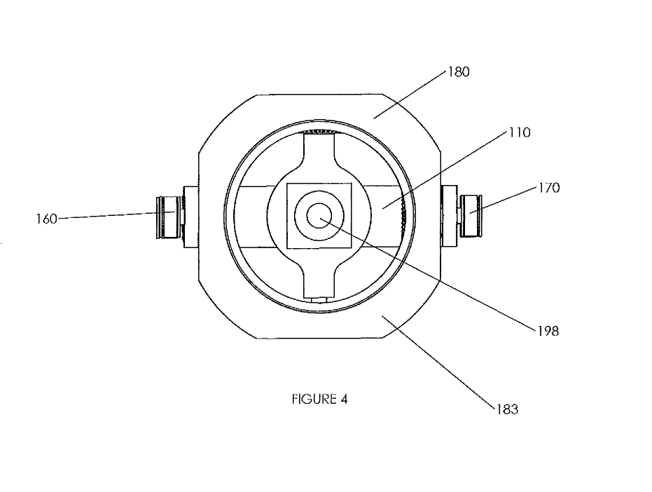

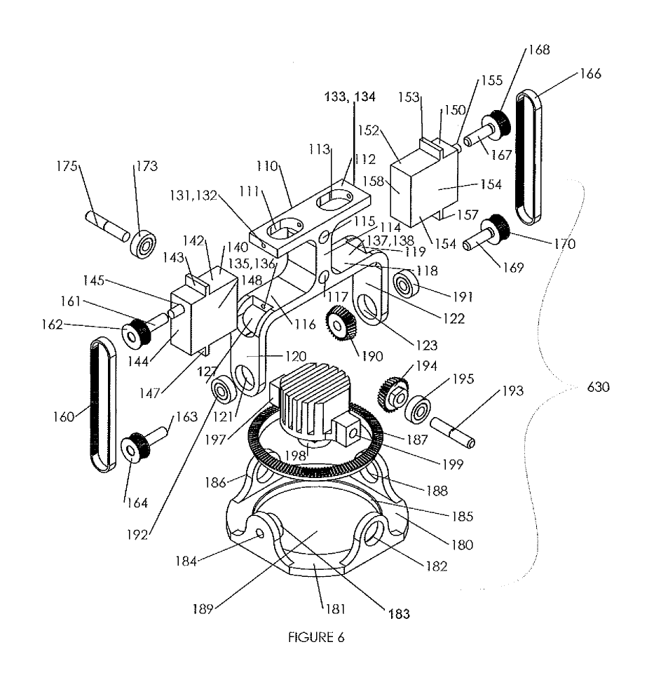

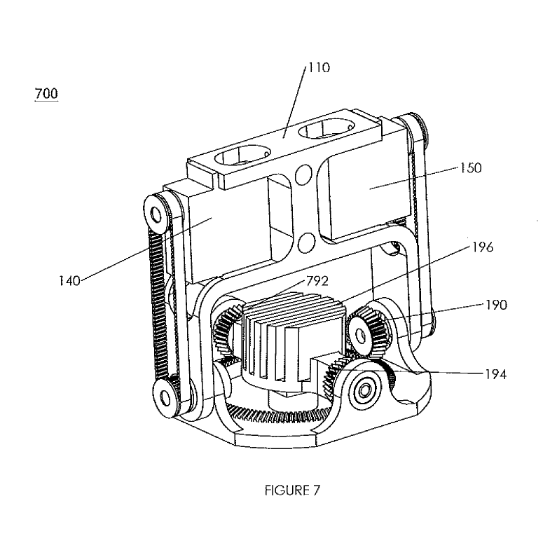

FIGS. 1-20 show rotatable platform devices according to embodiments. It will be understood that the devices are not limited to the configuration and combination of embodiments shown in the figures. It will be understood that the rotatable platform devices may include any combination of embodiments described with respect to the figures.

FIGS. 1 through 7 show different views of a rotatable platform device 100 according to some embodiments. As shown in FIG. 1, the rotatable platform device 100 may be configured to rotate a module 196 about at least two axes, a primary or first axis in a first direction and a secondary or second axis that is substantially perpendicular to the primary axis in a second direction. The device 100 may include at least one frame. In some embodiments, the device 100 may include a first frame 110 configured to hold at least one motor. In some embodiments, the first frame may be configured to hold two motors.

In some embodiments, the first frame 110 may be configured to hold two motors in an adjacent position. For example, in some embodiments, the output shafts of the motors can be in an aligned position. In other embodiments, the motors can be disposed next to each other to further shrink the outer envelope, the motors can be disposed in an offset position (e.g., off to the side allowing a channel to the mounted element above and below), among others. This channel could be useful for movement of air for heat dissipation as well as passage of other electrical, optical, or mechanical components needed to operate the element.

As shown in FIG. 1, the first frame 110 may include a first section 114 disposed between a second section 112 and a third section (116 and 118). The first section 114 may be configured to extend and be perpendicular between the second section 112 and the third section (116 and 118). In some embodiments, the first frame 110 may include extending members 120 and 122 extending from the third section (116 and 118). The sections may have any length. In some embodiments, the first section 114 may have a length that is shorter than the length of the third section (116 and 118). In other embodiments, the lengths may be different. In some embodiments, the first section 114 may be disposed substantially in the middle of the second section 112 and the third section (116 and 118) so as to create so as to create separate cavities, each configured to hold a motor. The first section 114 may also divide the third section into surfaces 116 and 118. In other embodiments, the first section 114 may be disposed at a different position with respect to the second section 112 and the third section (116 and 118). In some embodiments, the different position may depend and/or correspond to the shapes of the motors.

In some embodiments, the first frame 110 may include extending members 120, 122 that can be configured to attach to a second frame 180. In some embodiments, the extending members 120, 122 may extend from each side of the third section (116 and 118).

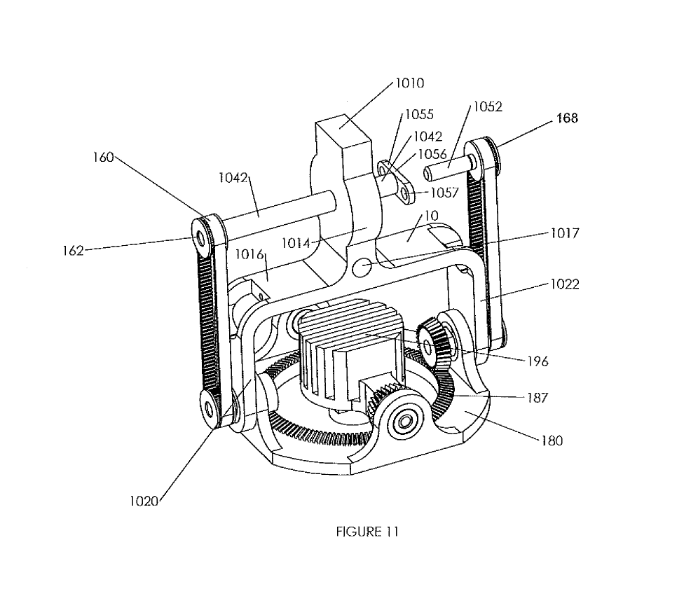

The first frame may have any shape. In some embodiments, the first frame may have a stir-up like shape as shown in FIG. 1. In other embodiments, the first frame 110 may have a different shape. FIGS. 10, 11, 15-17 and 18-20 show examples of different shapes and configurations of the first frame (discussed in more detail below) according to embodiments. In some embodiments, the motors, as well as the corresponding rotatable members and/or mechanical drive members (e.g., gear drives, belt drives, shafts and related linkage and fasteners), may be mounted substantially directly on the drive shafts for the primary and secondary axes.

In some embodiments, the first frame 110 may include at least one section configured to hold the motors. In some embodiments, the first frame 110 may include a plurality of sections. In some embodiments, at least one of the sections may include at least one connector to fixedly dispose the motor to the frame.

In some embodiments, the second section 112 may include a plurality of connectors configured to fixedly dispose a motor to the first frame 110. In some embodiments, the connectors may be an aperture with and/or without threading. In some embodiments, the second section 112 may include a connector 131 disposed on side surface 132 and a connector 133 disposed on a side surface 134. In some embodiments, the second section 112 may include a connector 135 disposed on a side surface 136 and a connector 137 disposed on the opposing side surface 138.

In some embodiments, the first frame 110 may include openings configured to provide access to the motor (e.g., inputs and outputs). In some embodiments, the first frame 110 may include a first opening 111 and a second opening 113 disposed in the second section 112 for a connection to a power source and/or a controller (e.g., circuit board).

In some embodiments, the first frame 110 may include openings 117 and 119 disposed between the third section (116, 118) and the respective extending member 120 and 122, respectively.

In some embodiments, the extending side members 120 and 122 may include openings or connectors 121 and 123, respectively, disposed adjacent to an end opposite of the end that includes the openings 117 and 119. The openings 121 and 123 may be configured to receive a fastener to connect the first frame 110 to a second frame 180 and/or rotatable members.

In some embodiments, the device 100 may include a first motor and a second motor. The first motor may be configured to drive a module in the first or primary axis and the secondary motor may be configured to drive the device in the second or secondary axis.

The first motor and the second motor may have any shape and/or dimensions. In some embodiments, the first motor and the second motor may have the same shape and/or dimensions. In other embodiments, the first motor and the second motor may have a different shape and/or dimensions. In some embodiments, as shown in FIGS. 1-6, the first motor and the second motor may have a rectangular shape. In other embodiments, the first motor and the second motor may have a different shape. For example, the first motor and the second motor may have a cylindrical shape, for example, as shown in FIGS. 10 and 11 (discussed in more detail below).

In some embodiments, the first motor and/or the second motor may be fixedly disposed with respect to at least the first frame. In other embodiments, the first motor and/or the second motor may be rotatably disposed with respect to the first frame, for example, as shown in FIGS. 10 and 11.

In some embodiments, for example, as shown in FIGS. 1-6, the first motor and the second motor may include protruding members configured to be disposed adjacent to edges of the first frame. For example, as shown in FIGS. 1-6, the first motor 140 may include protruding members 143 and 147 that protrude from opposing sides 142 and 144, respectively; and the second motor 150 may include protruding members 153 and 157 that protrude from opposing sides 152 and 154, respectively. The protruding members 143 and 147 may be configured to be adjacent to edges 132 and 136 of the first frame of the first frame; and the protruding members 153 and 157 may be configured to be adjacent to edges 134 and 138 of the first frame 110.

In some embodiments, the first and second motors 140 and 150 may be fixedly disposed to the first frame 110 using fasteners. The fasteners may include but is not limited to screws, nails, adhesive, or the like. In some embodiments, the protruding members 143, 147, 153, and 157 may include one or more connectors that are configured to align with the connectors of the first frame 110. The connectors may be configured to receive fasteners. The connectors may include but are not limited to apertures.

In some embodiments, the first and second motors 140 and 150 may each include an output or drive (also referred to as “shaft” and “drive shaft”) 145 and 155. The outputs 145 and 155 may be configured to cause a rotatable member and/or mechanical drive member to rotate to cause a module to rotate in the first and/or secondary axes. In some embodiments, the output 145 may be configured to rotate the module in a first or primary axis and the output 155 may be configured to rotate the module in a second or secondary axis.

In some embodiments, the device 100 may include a second frame 180. The second frame 180 may be configured to be pivotable with respect to the first frame 110 in the primary or first axis.

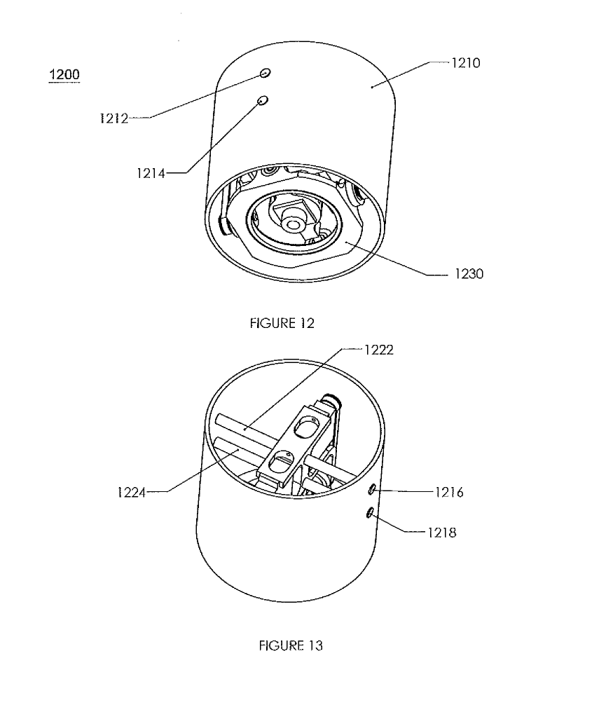

In some embodiments, the extending members of the first frame 110 may be fixedly disposed with respect to the second frame 180. In some embodiments, the first frame 110 and the second frame 180 may be fixedly disposed with respect to each other, for example, as shown in FIGS. 1-8. In other embodiments, the first frame 110 and the second frame 180 may be fixedly disposed with respect to another frame, for example, as shown in FIGS. 12-19.

In some embodiments, the second frame 180 may include a plurality of protruding members that protrude from a base surface 181. The protruding members may be configured to be attached to the module and/or rotatable members. In some embodiments, the second frame 180 may include four protruding members 182, 184, 186, and 188 that protrude from the base surface 181. In other embodiments, the second frame 180 may include more or less protruding members (e.g., three protruding members). The protruding members may each include a connector configured to fixedly attach to the second frame, the rotatable members and/or module. The connector may include an aperture.

The second frame 180 may also include an opening 189 in which the module 196 may be aimed, for example, for projecting a light. The opening 189 may be circular. In other embodiments, the opening may have any dimensions and/or shape.

The device 100 may include a plurality of rotatable members and/or mechanical drive members configured to rotate the second frame and/or the module. The rotatable members and/or mechanical drive members may include but is not limited to belts, gears, rotatable shafts, the like, among others, or a combination thereof. FIGS. 1-20 show different examples of rotatable members and/or mechanical drive members according to embodiments.

As shown in FIG. 1, the device 100 may include a set of rotatable members disposed on opposing sides of the first frame 110 and the second frame 180. In some embodiments, each set of rotatable members may include at least two rotatable members. In some embodiments, each set of rotatable members may include three or more rotatable members. The device 100 may include a first set of members 162 and 164 disposed on one side and a second set of members 168 and 170 disposed on the opposing side. The members 162 and 168 may be disposed on the outputs 145 and 155 of the motors 140 and 150, respectively, via drive shafts (also referred to as drive shafts) 161 and 167. The members 164 and 170 may be disposed on the opposing sides of the first frame at connectors 121 and 123, respectively. The members 164 and 170 may be fixedly disposed to the second frame 180 via connectors 184 and 188, respectively.

In some embodiments, the device 100 may include a first mechanical drive member 160 and a second mechanical drive member 166 disposed between the first set of rotatable members (162, 164) and second set of rotatable member (168, 170), respectively. In some embodiments, the first and second mechanical drive members may be a belt disposed on and/or between each set of rotatable members as shown in FIGS. 1-17. The belts may be any type of belt. The belts may include but are not limited to Vee belts, grooved belts, ribbed belts, flat belts, among others, or a combination thereof.

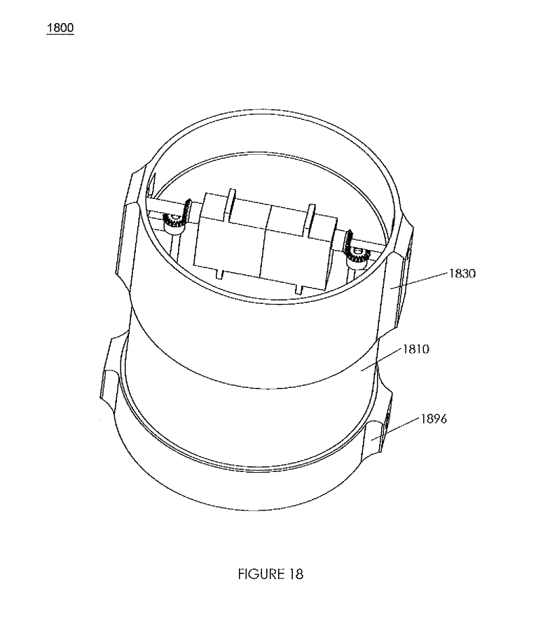

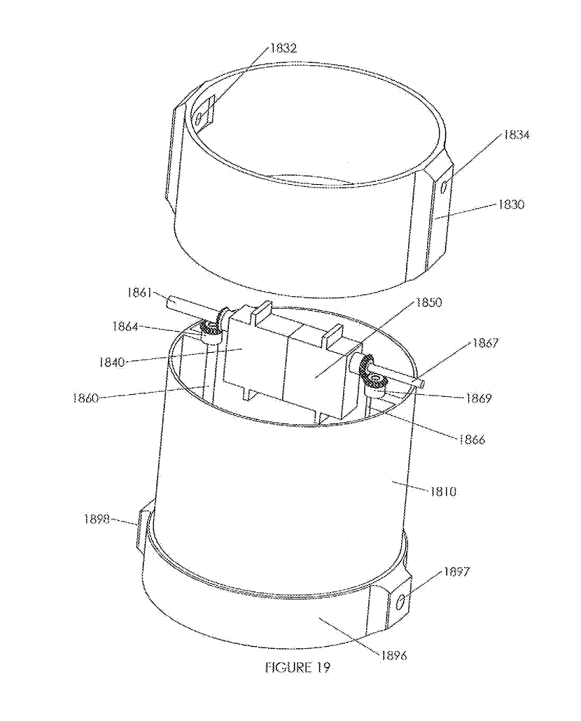

In some embodiments, the first and second mechanical drive members may be rotatable shafts, for example, as shown in FIGS. 18-20. In other embodiments, the first and second mechanical drive members may be a different rotatable component.

In some embodiments, the device may include a plurality of rotatable members configured to rotate the module 196 about the first axis and/or second axis. The members may be gears, including but not limited to smooth gears, teethed gears, for example, but not limited to helical gears, bevel gears, spiral gears, among others.

In some embodiments, the device may include at least two drive shafts (also referred to as shafts and/or outputs) configured to cause the module to rotate about the first axis and/or second axis. In some embodiments, the device may include at least a first drive shaft that is configured to cause the module to rotate about the first axis and a second drive shaft that is configured to cause the module to rotate about the second axis. In some embodiments, the first and second drive shafts may be configured to also act as the primary axis axle.

In some embodiments, at least one of the drive shafts may be rotatably disposed with respect to a frame to cause the one or more rotatable members to rotate to cause the module 196 to rotate about the first and/or second axes. In some embodiments, all of the drive shafts may be rotatably disposed with respect to a frame, for example, as shown in FIGS. 1-17. In some embodiments, at least one of the first and second drive shafts may be rotatably disposed with respect to the frame and at least one of the drive shafts may be fixedly disposed with respect to a frame to cause the one or more rotatable members to rotate to cause the module 196 to rotate about the first and/or second axes, for example, as shown in FIGS. 18-20.

In some embodiments, as shown in FIGS. 1-6, the device 100 may include a first drive shaft 163 that is rotatably disposed with respect to the member (also referred to as rotatable member) 164. The member 164 may be configured to cause the first drive shaft 163 to rotate and thereby cause the module to rotate about the first axis (about members 164, 170). The member 164 and shaft 163 may be rotatably disposed with respect to the second frame 180 by (circular and rotatable) member 183.

In some embodiments, the device may include a second drive shaft 169 that is rotatably disposed with respect to the member (also referred to as rotatable member) 170. The member 170 may be configured to cause the second drive shaft 169 to rotate and thereby cause the module to rotate about the second axis (about shafts 175, 193).

In some embodiments, the members and/or drive shafts may be disposed with respect to the first frame 110 and/or second frame 180. In some embodiments, the member 164 and shaft 163 may be disposed at the connector (also referred to as opening or aperture) 121 of the first frame 110 and at the connector 184 of the second frame, for example, to member 183 via member 121. The member 170 and the shaft 169 may be disposed at the connector (also referred to as opening or aperture) 123 of the first frame 110 and at the connector 123 of the second frame 180, for example, to member 190 via member 191.

In some embodiments, the second drive shaft 169 may cause one or more rotatable members (e.g., gears or pinions) to rotate to thereby cause the module 196 to rotate about the second axis. In some embodiments, the device may include at least two gears or pinions (a first gear or pinion 190 and a second gear or pinion 194), for example, as shown in FIGS. 1-6. In some embodiments, the gears may have the same shape and/or dimensions, different shape and/or dimensions, or a combination thereof. In some embodiments, the device may include more than two gears.

In some embodiments, one or more of the gears may be rotatably disposed with respect to the first frame 110 and/or the second frame 180. The first gear 190 may be configured to be disposed on a side of the second frame 180 opposing and/or rotatably disposed with respect to the rotatable member 170. The first gear 190 may be configured to rotate with the rotatable member 170 about the primary axis. The first gear 190 and the corresponding drive shaft 169 may be configured to also act as the primary axis axle. The second gear 194 may be disposed adjacent to the first gear 190 between the rotatable mechanical drive members 160 and 166 on either side of the second frame 180. The second gear 195 may be configured to act as the secondary axis axle.

The gears may be configured to be disposed within the connectors of the second frame 180. The first gear 190 may be configured to be fixedly disposed with respect to connector 123 of the frame 110 and the connector 188 of the second frame. The second gear 194 may be configured to be fixedly disposed at the connector 182 of the second frame 180 via member 195, for example, as shown in FIG. 1. In other embodiments, the second gear 194 may be configured to be fixedly disposed with respect the second frame 180 at the connector 186.

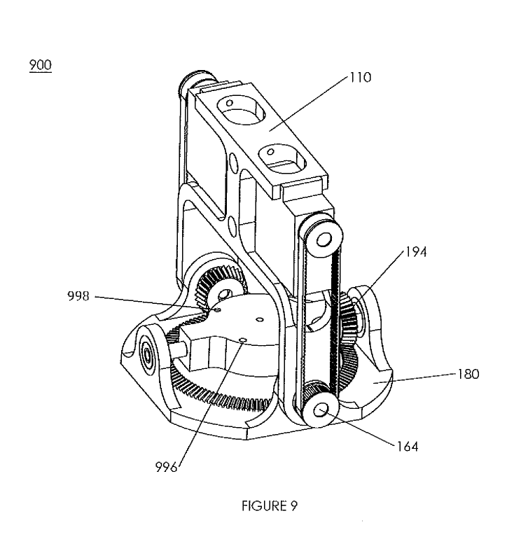

In some embodiments, the device may include a third gear or pinion that is disposed on the opposite side of the second frame. For example, as shown in FIGS. 7 and 8, a device 700 may include a third gear 792 disposed on the second frame 180 at the connector 186. The third gear 792 may be adjacent to the first gear 190 on the side of the second frame opposing the second gear 194. The third gear 792 may be rotatably disposed at the second frame 180 via a member (like member 195) like the second gear 194.

In some embodiments, the device 100 may include a rotatable circular gear or rack 187 disposed on the second frame 180 surrounding the opening 189. The rack 187 may be attached to the second frame 180 using any known fastener, for example, indentation 185.

In some embodiments, the members 173, 191, 192, and 195 may have any shape complementary to the respective connectors (e.g. openings and apertures) of the first frame 110 and/or the second frame 180. In some embodiments, the members 173, 191, 192 and 195 may have a circular shape. The member 183 may also have any complementary shape. In some embodiments, the member 183 may have a flat side surface and/or any shape so that the member 183 does not connect and/or interfere with the rack 187. The members 173, 183, 191, 192, and 195 may also include one or more openings configured to receive a shaft and/or fastener.

In some embodiments, the members 173, 183, 191, 192, and 195 may be separated from the first frame 110 and/or the second frame 180. In other embodiments, the members 173, 183, 191, 192, and 195 may be integrated with the first frame 110 and/or the second frame 180.

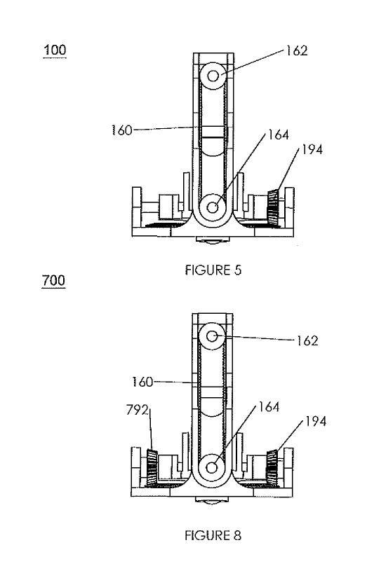

The device 100 may include the module 196 that is configured to be rotatably disposed with respect to the second frame 180. The module 196 may include any light source (e.g., as shown in FIGS. 1-6), any lighting source (e.g., LED, LCD, UV, etc.), any optical element (e.g., lens, a mirror, or prism), among others, or a combination thereof. In some embodiments, the module 196 may include a heat sink. As shown in FIG. 4, the module 196 may include a light source 198.

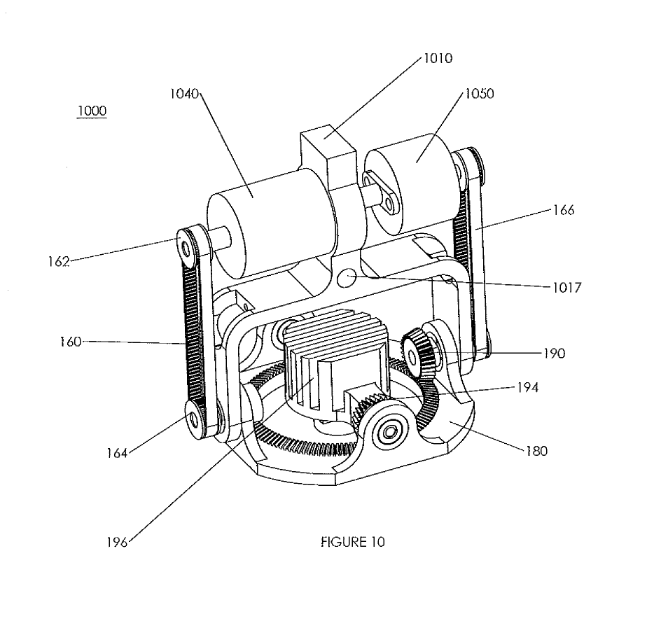

In some embodiments, the module 196 may include a platform configured to receive any light source, lighting source, optical element, etc. For example, as shown in FIG. 9, the device 900 may include a module 996 that includes a platform on which another module (e.g., any light source, lighting source, optical element, etc.) may be fastened via connectors 998 (e.g., threaded or non threaded holes and/or depressions).

The module 196 may be disposed and configured to rotate perpendicular to the set of mechanical drive members 160 and 166. The module 196 may be disposed with respect to connectors 186 and 182 via connectors 197 and 199. The connectors may be apertures 197 and 199 configured to receive rotatable shafts 175 and 193, respectively. The shafts 175 and 193 may be disposed to the second frame 180 using members 173 and 195, respectively. The members 173 and 195 may have the substantially the same size as apertures 182 and 186.

In operation, the first motor 140 may be configured to rotate the module 196 in the first axis by causing the mechanical drive member 160 to rotate the second frame 180 about shafts 163 and 169 (rotatable members 164 and 170). The second motor 150 may be configured to rotate the module 196 about the secondary axis by causing the mechanical drive member 166 to rotate the first gear 190 thereby causing the gear 187 and the second gear 194 (and/or third gear 792) to rotate. When the second gear 194 and/or the third gear 792 are caused to rotate, the module 196 may be caused to rotate about the shafts 175 and 193 (the secondary axis).

In some embodiments, the first motor and the second motor may at least be partially rotatably disposed with respect to at least one frame. The frame(s), such as, for example, the first frame, may be modified to be configured to hold rotatably mounted motors. FIGS. 10 and 11 and 18-20 show examples of devices according to some embodiments. FIGS. 10 and 11 show an example of a device 1000 with rotatably mounted motors 1040 and 1050 and a first frame 1010.

As shown in FIGS. 10 and 11, the first frame 1010 may have a stir-up configuration similar to the first frame 110. The first frame 1010 may include a first section 1014 disposed between a second section 1012 and a third section (1016 and 1018). The first section 1014 may be configured to extend and be perpendicular between the first section 1012 and the third section (1016 and 1018). In some embodiments, the first frame 1010 may include extending members 1020 and 1022 extending from the third section (1016 and 1018). The sections may have any length. In some embodiments, the first section may have a length that is shorter than the length of the third section (1016 and 1018). In other embodiments, the lengths may be different. In some embodiments, the first section 1014 may be disposed substantially in the middle of the second section 1012 and the third section (1016 and 1018). The first section 1014 may also divide the third section into surfaces 1016 and 1018. In other embodiments, the first section 1014 may be disposed at a different position with respect to the second section 1012 and the third section (1016 and 1018). In some embodiments, the different position may depend and/or correspond to the shapes of the motors.

The device may include a first motor 1040 configured to cause the module 196 to move in the primary axis and a second motor 1050 configured to cause the module 196 to move in the secondary axis. The motors 1040 and 1050 may be mounted on at least one rotatable shaft.

In some embodiments, the first frame may include at least one (rotatable) drive shaft between the rotatable member 162 and the first section 1014 and at least one (rotatable) drive shaft between the rotatable member 168 and the first section 1014. The first motor 1040 may be mounted on the first rotatable shaft 1042. The second motor 1052 may be mounted on the first rotatable shaft 1042 and a second rotatable shaft 1052. The second motor 1052 may be attached to the first rotatable shaft 1042 with a fastener member 1056 having apertures 1055 and 1057. The second motor 1050 may configured to drive the secondary axis and the first motor 1040 may be configured to drive the primary axis. In this way, the output shafts of the motors may be substantially aligned.

In operation, by substantially aligning the output shafts of the two motors, the drive shaft of the motor on the secondary axis may move with the drive shaft of the primary axis when the secondary axis motor is not in motion. This can directly mechanically negate the movement of the secondary axis motor that occurs as a result of movement of the primary axis against the rotatable member that drives the secondary axis as the rotatable member can be configured to move with the primary axis. Action of the motor driving the secondary axis can have substantially no direct effect on the primary axis. For example, if the desired angular position of the mechanism is (a₁, a₂), the output shaft of the primary axis can be configured to move to a₁, and the secondary axis can be configured to be moved to a₂.

In other embodiments, for example, in FIGS. 1-6, motion of the secondary axis due to movement of the primary axis can be eliminated via calibrated adjustments to the position of the secondary axis. This can be accomplished via programmed correction or electrical control system. This can be easily accomplished because the motion of the secondary axis is linear. If the desired angular position of the mechanism is (a₁,a₂), the output shaft of the primary axis can be configured to move to a₁, and the secondary axis can be configured to be moved to a₂−a₁.

FIGS. 18-20 show example of a device 1800 capable of mechanically negating the motion of the secondary axis due to the movement of the primary axis. FIG. 20 shows a view of the device 1800 with a first frame 1810 removed. In some embodiments, the device body 2000 may include a second frame 1880 having components as shown in and described with respect to FIGS. 1-17.

In some embodiments, the device 1800 may include first motor 1840 and a second motor 1850 disposed adjacent to each other. For example, the first motor 1840 and the second motor 1850 may be joined together, for example, using any fastener, such as adhesive, and/or integral with each other. The device 1800 may include a first frame 1810. In some embodiments, the first frame 1810 may have a circular shape.

In some embodiments, the device 1800 may include a first drive shaft 1861 that is disposed on the first motor 1840 and a second drive shaft 1867 disposed on the second motor 1850. The motors may be disposed so that the drive shafts 1861 and 1867 are substantially aligned and are configured to rotate together. In some embodiments, the first drive shaft 1861 may be fixedly disposed to a frame (e.g., a second frame 1830) and the second drive shaft 1867 may be rotatably disposed with respect to the frame (e.g., a second frame 1830). In this way, the first drive shaft 1861 can be fixedly disposed with respect to the frame(s) and the motors may be rotatably disposed with respect to the frame(s). The first motor 1840 may configured to cause the module 196 to move in the primary axis and a second motor 1850 may configured to cause the module 196 to move in the secondary axis. In some embodiments, the first drive shaft 1861 and the second drive shaft 1862 (also referred to as extending members) may be configured to connect the first frame 1810 to the second frame 1830 via connectors 1832 and 1834 (e.g., openings) of the second frame 1830.

In some embodiments, the device 1800 may include a first set of rotatable members 1862, 1864, 1865, and 1871 and a second set of rotatable members 1868, 1869, 1881, and 1882. At least one rotatable member of each set may be disposed on or adjacent to the first frame 1810. The sets of rotatable members may include but are not limited to gears (e.g., pinion gears). In some embodiments, the device 1800 may include a first mechanical drive member 1860 disposed between the first set of rotatable members and a second mechanical drive member 1866 disposed between the second set of rotatable members. The first and second mechanical drive members 1860, 1866 may be configured to rotate. In some embodiments, the first and second mechanical drive members 1860, 1866 may each be a vertical drive shaft. In other embodiments, the mechanical drive members may be a different rotational component.

In some embodiments, the rotatable member 1862 may be disposed on the first motor 1840 and drive shaft (output) 1861; the rotatable member 1864 may be disposed on an end of the first mechanical drive member 1860 substantially perpendicular to the rotatable member 1862; the rotatable member 1865 may be disposed on the opposing end of the first mechanical drive member 1860; and the rotatable member 1871 may be disposed on a drive shaft 1863 and within the second frame 1880 and substantially perpendicular to the rotatable member 1865. In some embodiments, the rotatable member 1868 may be disposed on the second motor 1850 and on the drive shaft (output) 1867; the rotatable member 1869 may be disposed on an end of the second mechanical drive member 1866 substantially perpendicular to the rotatable member 1868; the rotatable member 1881 may be disposed on the opposing end of the second mechanical drive member 1866; and the rotatable member 1882 may be disposed on a drive shaft 1873 and within the second frame 1880 and substantially perpendicular to the rotatable member 1881. In some embodiments, the drive shaft 1863, like shaft 1861, may be fixedly disposed with respect to a frame (e.g., the second frame 1880 and/or fourth frame 1896). The drive shaft 1873, like shaft 1867, may be rotatably disposed with respect to a frame (e.g., the second frame 1880 and/or the fourth frame 1896).

The device 1800 may include a first gear 1890 configured to be disposed on a side of the second frame 1880 opposing and/or rotatably disposed to the rotatable member 1871. Like FIGS. 1-17, the first gear 1890 may be configured to rotate with the rotatable member 1882 about the primary axis. The first gear 1890 may be perpendicular to the rotatable member 1881. The second gear 1894 may be disposed adjacent to the first gear 1890 between the mechanical drive members 1860 and 1866 on either side of the second frame 1880.

In operation, the first motor 1840 may be configured to rotate the module 196 in the first axis by causing the mechanical drive member 1860 to rotate the second frame 1880 about the shafts 1863 and 1873. The first motor 1840 may be configured to cause the rotatable member 1862 to rotate (due to the shaft 1861 being fixedly disposed) to thereby cause the rotatable member 1864 to rotate. The rotatable member 1864 may then cause the mechanical drive member 1860 to rotate, which thereby causes the rotatable member 1865 to rotate. The rotatable member 1865 may then cause the rotatable member 1871 to rotate. The rotation of the rotatable member 1871 may cause the second frame 1880 and therefore the module 196 to rotate about the first axis (shafts 1863 and 1873) because the shaft 1863 is fixedly disposed. When the first motor 1840 causes the rotatable member 1862 to rotate, the first motor 1840 and the second motor 1850 can then be caused to substantially simultaneously rotate about the shaft 1867. The rotating of the motors can cause the rotatable member 1868 and the shaft 1867 to rotate to thereby cause the second drive member 1866, the rotatable members 1881 and 1882, and gears 1890 and 1894 to rotate. This can thereby cause the module 196 to rotate about the second axis but does not substantially change the position of the module 196 with respect to the secondary axis. This movement in the second axis can mechanically compensate for any movement of the module 196 with respect to the second frame 1880 caused by movement in the primary axis. In this way, the position of the module 196 with respect to the second frame can be substantially fixed in the secondary axis while moving the module 196 in the first axis.

The second motor 1850 (while substantially stationary) may be configured to rotate the module 196 about the secondary axis independent from the movement of the module 196 in the primary axis. The second motor 1850 may cause the rotatable member 1868 and the shaft 1867 to rotate to thereby cause the second mechanical drive member 1866 (due to the shaft 1867 acting as an idler axle). The rotation of the second mechanical drive member 1866 may cause the rotatable member 1881, which can thereby cause the rotation of rotatable member 1882 and the gear 1890. The rotation of the gear 1890 may cause the gear 1894 (due to the rack 187 rotating). When the second gear 1894 is caused to rotate, the module 196 may be caused to rotate about the shafts 1875 and 1893 (the secondary axis).

In some embodiments, the device may include a third frame or housing. The third frame may be configured to fit retroactively into existing fixtures, for example, light fixtures that can include but not limited to wall sconces and recessed lighting fixtures. FIGS. 12 through 19 show examples of devices according to these embodiments.

As shown in FIGS. 12 through 14, the device 1200 may include a third frame 1210. The third frame 1210 may have a hollow, cylindrical shape. In other embodiments, the third housing 1210 may have a different shape.

The third frame 1210 may be configured to externally surround the device body 1230. As shown in FIGS. 12-14, the device body 1230 substantially corresponds to the device 100, shown in FIGS. 1-11. In other embodiments, the device body 1230 may correspond to the devices according to other embodiments, for example, to the devices 900 and 1000.

In some embodiments, the third frame 1210 may be configured to be fixedly disposed about the device body 1230. In some embodiments, the device 1200 may include a plurality of connectors. In some embodiments, the connectors may include apertures and corresponding elongated members(s).

In some embodiments, the third frame 1210 may include at least two apertures, each provided on opposing sides of the frame 1210. In some embodiments, the third frame 1210 may have more than two apertures, for example, the third frame 1210 may have four apertures. As shown in FIGS. 12 and 13, the third frame may have apertures 1212 and 1214 disposed on one side of the frame 1210 and may have apertures 1216 and 1218 disposed on the opposite side of the frame 1210. The apertures may have the same shape and dimensions, different shape and dimensions, or a combination thereof.

In some embodiments, the device 1200 may include at least one elongated member. In some embodiments, the device 1200 may include at least two elongated members 1222 and 1224. The elongated members 1222 and 1224 may have the same shape and dimensions, different shape and dimensions, or a combination thereof. The members may have a diameter corresponding to the respective aperture.

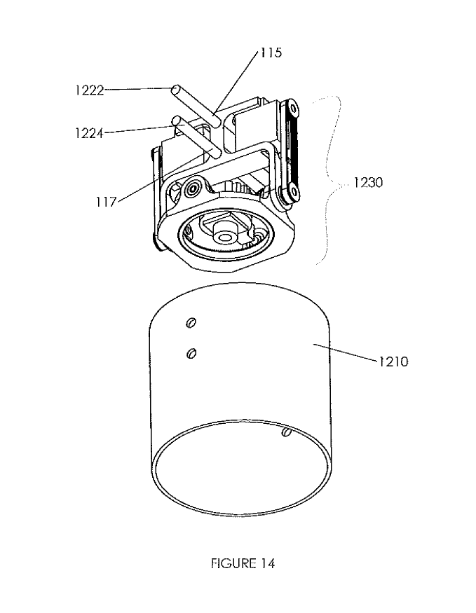

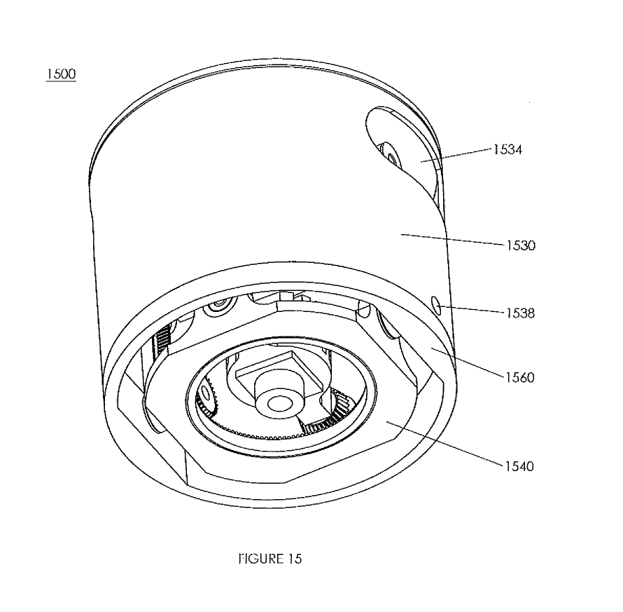

The elongated member(s) may be configured to extend through the first frame of the device and may be fixedly disposed to the apertures of the third frame. For example, as shown in FIG. 14, the elongated members 1222 and 1224 are configured to extend through apertures 115 and 117 of the device body 1230 to the apertures 1212 and 1216, and the apertures 1214 and 1218 of the third frame 1210, respectively.

In some embodiments, for example, the device housing may include an aperture for each elongated member. For example, as shown in FIGS. 10 and 11, the device 1000 may include an aperture 1017 configured to receive an elongated member. In some embodiments, the device housing may include more than one aperture.

In some embodiments, the third frame may include one or more apertures for receiving the elongated member(s), for example, as shown in FIGS. 15-19.

In some embodiments, the third frame may be fixedly disposed using different kinds of connectors. For example, as shown in FIGS. 15-17, the device 1500 may include a first frame 1510 configured to be fixedly disposed on one side of a third frame 1530. In some embodiments, the device 1500 may further include a fourth frame 1560 configured to be fixedly disposed on the opposite side of the third frame 1530 and a second frame 1580.

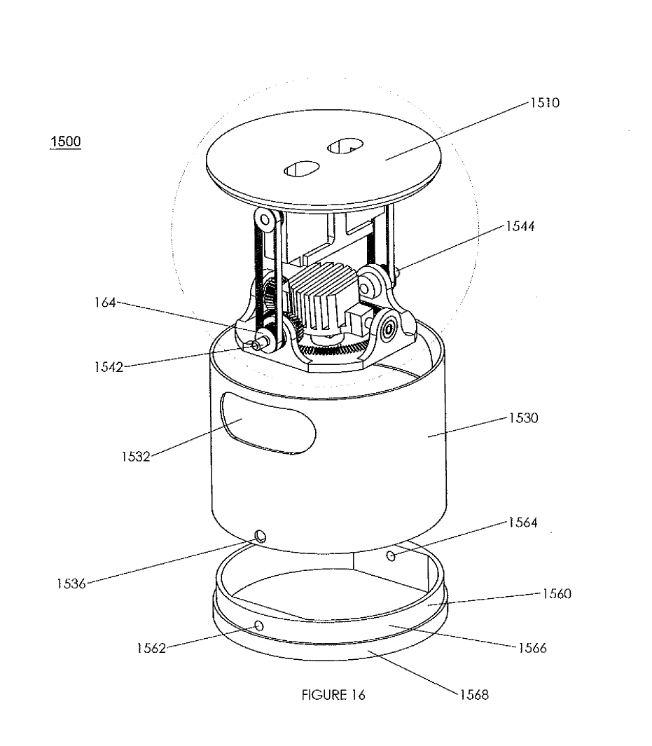

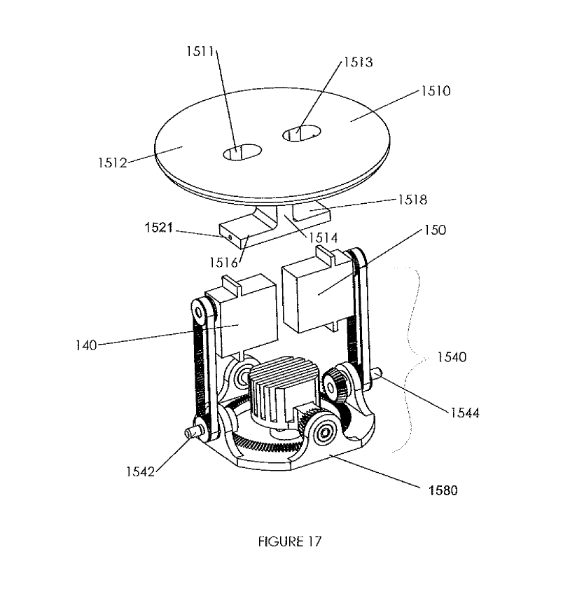

In some embodiments, the first frame 1510 may be configured to be supported by the third frame 1530 and thus may omit the extending members configured to connect to the second frame. As shown in FIGS. 16 and 17, the first frame 1510 may be configured to hold two motors in an adjacent position, like the first frame 110.

In some embodiments, the first frame 1510 may include a first section 1514 disposed between a second section 1512 and a third section (1516 and 1518). The first section 1514 may be configured to extend and be perpendicular between the second section 1512 and the third section (1516 and 1518). In some embodiments, the second section 1512 may be configured to be fixedly disposed on one side of the third frame 1530. The second section 1512 may substantially have the same shape and dimensions as the diameter of the third frame 1530. In some embodiments, the second section 1512 may include at least one opening configured to receive the power source (input). The second section 1512 may include two openings 1511 and 1513. The first frame 1510 may also include connectors like connectors of the first frame 110 to fixedly or rotatably dispose the motors 140 and 150. For example, the first frame 1510 may include at least one opening 1521 and another opening (not shown) on opposing sides of the third section (1516 and 1518), respectively.

In some embodiments, the first section 1514 may be disposed substantially in the middle of the second section 1512 and the third section (1516 and 1518) so as to create so as to create separate cavities, each configured to hold a motor. The first section 1514 may also divide the third section into surfaces 1516 and 118. In other embodiments, the first section 1514 may be disposed at a different position with respect to the second section 1512 and the third section (1516 and 1518). In some embodiments, the different position may depend and/or correspond to the shapes of the motors.

In some embodiments, the device 1500 may also include a device body 1540. In some embodiments, the device body 1540 may include substantially the same components of the device 100 but for the first frame 1510 and protruding connectors 1542 and 1544 protruding from the primary axis rotation members. In other embodiments, the device body 1540 may have a different shape.

In some embodiments, the device 1500 may include a fourth frame 1560 configured to be fixedly disposed on the opposite side of the third frame 1530. The fourth frame 1560 may include a first section 1566 and a second section 1568. The first section 1566 and the second section 1568 may have the same or different diameters and/or shapes. In some embodiments, the first section 1566 may have an outer diameter that is smaller than the outer diameter of the second section 1568 and the third frame 1530. The first section 1566 may be configured to be disposed within the third frame 1530. The second section 1568 may have a diameter that is the same as the third frame 1530 so as to substantially align with the third frame 1530 when fixedly disposed. The first section 1562 may include at least two opposing apertures 1562 and 1564 that can be configured to align with apertures 1536 and 1538 and the protruding members 1542 and 1544 of the body 1540.

In some embodiments, the frames of the device 1500 may be fixedly connected to each other by placing the first frame 1510 into one side of the third frame and by placing the fourth frame 1560 on the opposing side and rotating the fourth frame 1560 with respect to the first, second, and third frames, until the apertures 1562 and 1564 are aligned with apertures 1536 and 1538 and the protruding members 1542 and 1544 of the body 1540.

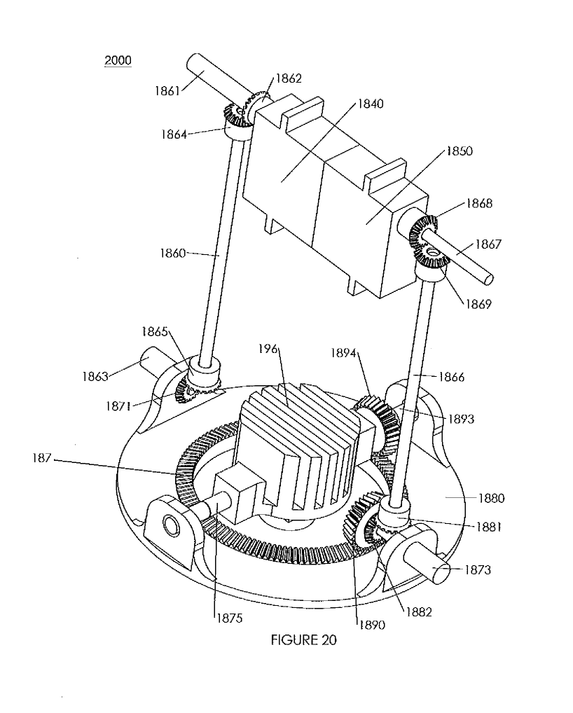

In some embodiments, the frames of the device may be fixedly connected to each other using the output or drive shafts, for example, as shown in FIGS. 18 and 19. In some embodiments, the device 1800 may include a third frame 1830 and/or a fourth frame 1896. Each of the frames may include apertures to receive shafts. In some embodiments, the third frame 1830 may include apertures 1832 and 1834 disposed on opposing sides, for example, to receive the shafts 1861 and 1867. In some embodiments, the fourth frame 1896 may include apertures 1897 and 1898 disposed on opposing sides, for example, to receive the shafts 1863 and 1873. The third frame 1830 and the fourth frame 1896 may be configured to be fixedly disposed with respect to the first frame 1810 and the second frame 1880 by disposing the drive shafts with respect to the apertures.

In some embodiments, the devices may include a power source. The devices may include a backup power source, such as a backup battery, and/or a conventional plugged-in power source. The devices may include an AC or DC power source. The devices may be configured for a power source of 12V.

In some embodiments, the devices may include a controller configured to control at least one device. In some embodiments, the controller may be configured to control a plurality of devices.

The controller may be may any known central processing unit, processor, microprocessor, or microcontroller. The controller may be coupled directly or indirectly to memory elements. The memory may include random access memory (RAM), read only memory (ROM), disk drive, tape drive, etc., or a combinations thereof. The memory may also include a frame buffer for storing image data arrays. The present disclosure may be implemented as a routine that is stored in memory and executed by the controller. The controller may also include micro instruction code. The various processes and functions described herein may either be part of the micro instruction code or part of the application program or routine (or combination thereof) that is executed via the controller.

The controller may be configured to control the device according to stored parameters and/or positions. In some embodiments, for example, for a lighting device, the parameters may relate to projected light (e.g., the intensity of the light, the diameter of projected light, the color of the light, among others).

In some embodiments, the controller may be configured to control the device based on a remote controller. Remote controller may be a physical remote controller, a program provided on any computing device, a program provided on a mobile device (e.g., tablet, smart phone), any device configured for wired and/or wireless communications, among others. For example, using a computer, tablet, smartphone, or device with wired or wireless communication, users may specify movement to preprogrammed positions. Using a similar interface, users can specify new positions to move the mechanism dynamically. New positions can be stored for use in the future. Multiple positions could be stored allowing the mechanism to be guided through sequences of preprogrammed positions.

In some embodiments, the controller can be configured to use sensors and other data sources to calculate appropriate positions for the mechanism. The arrangement of the mechanical movement can allow for simple movement without any cylindrical coordinate calculations.

In one example application, high speed linear imaging elements such as CCDs or CMOS sensors that are aligned with the primary and secondary axis can be used to identify a target beacon. Due to the alignment of the optical and mechanical axes, the mechanism can be used to precisely aim at the beacon with minimal calibration.

In some embodiments, the devices may include at least one sensor. In some embodiments, the devices may include other data sources.

In some embodiments, the frames and components of devices may be made of a heat compatible material. In some embodiments, the devices may be made of a metal material and/or plastic material.

While the disclosure has been described in detail with reference to exemplary embodiments, those skilled in the art will appreciate that various modifications and substitutions can be made thereto without departing from the spirit and scope of the disclosure as set forth in the appended claims. For example, elements and/or features of different exemplary embodiments may be combined with each other and/or substituted for each other within the scope of this disclosure and appended claims.

1. A porosimetry process comprising:
providing an adsorption system having an adsorption chamber and a probe gas at a first temperature;
providing a porous material and placing the porous material within the adsorption chamber;
executing a porosimetry run on the porous material, the porosimetry run including:
(a) selecting an uptake target value;
(b) selecting a target interval bounding the uptake target value;
(c) adjusting pressure within the adsorption chamber in order for the porous sample to reach the uptake target value;
(d) adjusting pressure within the adsorption chamber until the pressure within the adsorption chamber is within the target interval for a predetermined amount of time; and
(e) repeating steps (a)-(d) until the porosimetry run is complete.

2. The porosimetry process of claim 1, further including:
determining if a predetermined pressure has been reached within the adsorption chamber after step (d);
cooling the probe gas from the first temperature to a predetermined lower second temperature if the predetermined pressure has been reached; and
repeating steps (a)-(d) using the probe gas at the second temperature until the porosimetry run is complete, the completed porosimetry run operable to obtain one complete set of pore size distribution data ranging from micropores to mesopores to macropores.

3. The porosimetry process of claim 2, wherein the probe gas is MeCl.

4. The porosimetry process of claim 3, further including the gravimetric adsorption system having a cooler operable to cool the probe gas from the first temperature to the second temperature.

5. The porosimetry process of claim 4, wherein the probe gas is cooled isobarically.

6. The porosimetry process of claim 5, wherein the porosimetry run is a single porosimetry run from 0.001 to 700 bar.

7. The porosimetry process of claim 5, wherein the porosimetry run is a single porosimetry run from 0.005 to 700 bar.

8. The porosimetry process of claim 5, wherein the porosimetry run is a single porosimetry run from 0.01 to 700 bar.

9. The porosimetry process of claim 1, wherein the target interval is less than or equal to +/−20% of the uptake target value.

10. The porosimetry process of claim 9, wherein the target interval is less than or equal to +/−15% of the uptake target value.

11. The porosimetry process of claim 10, wherein the target interval is less than or equal to +/−10% of the uptake target value.

12. The porosimetry process of claim 1, further including the gravimetric adsorption system having a probe gas inlet valve and a probe gas outlet valve and adjusting the pressure within the adsorption chamber is performed by the probe gas inlet valve or the probe gas outlet valve being in an open position.

13. The porosimetry process of claim 12, wherein the probe gas inlet valve and the probe gas outlet valve are both in the closed position when the pressure within the adsorption chamber is within the target interval.

14. The porosimetry process of claim 13, wherein the probe gas inlet valve is opened when the pressure in the adsorption chamber drops below the target interval.

15. The porosimetry process of claim 13, wherein the probe gas outlet valve is opened when the pressure in the adsorption chamber rises above the target interval.

16. A porosimetry process comprising:
providing a gravimetric adsorption system having an adsorption chamber, a probe gas at a first temperature, a probe gas inlet valve and a probe gas outlet valve;
providing a porous material and placing the porous material within the adsorption chamber;
executing a porosimetry run on the porous material, the porosimetry run including:
(a) evacuating the adsorption chamber to a predetermined vacuum pressure;
(b) selecting a probe gas uptake pressure target value;
(c) selecting a target interval bounding the probe gas uptake pressure target value, the target interval being at least +/−10% of the probe gas uptake pressure target value;
(d) flowing a predetermined amount of the probe gas into the adsorption chamber in order for the adsorption chamber to reach the probe gas uptake pressure target value;
(e) opening and closing the probe gas outlet valve and probe gas inlet valve in order to adjust the pressure within the adsorption chamber to be within the target interval for a predetermined amount of time; and
(f) repeating steps (a)-(d) until the porosimetry run is complete.

17. The porosimetry process of claim 16, wherein the probe gas inlet valve and the probe gas outlet valve are both in a closed position when the pressure within the adsorption chamber is within the target interval.

18. The porosimetry process of claim 17, wherein the probe gas inlet valve is opened when the pressure in the adsorption chamber rises drops below the target interval.

19. The porosimetry process of claim 18, wherein the probe gas outlet valve is opened when the pressure in the adsorption chamber rises above the target interval.

20. The porosimetry process of claim 19, further including:
determining if a predetermined pressure has been reached within the adsorption chamber after step (d);
cooling the probe gas from the first temperature to a predetermined lower second temperature if the predetermined pressure has been reached; and
repeating steps (a)-(d) using the probe gas at the second temperature until the porosimetry run is complete, the completed porosimetry run operable to obtain one complete set of pore size distribution data ranging from micropores to mesopores to macropores.
